(19) United States
(12) Patent Application Publication
(10) Pub. No.: US 2024/0402395 A1
(43) Pub. Date: Dec. 5, 2024

(54) PROTECTION FILM STRUCTURE WITH BENDABLE TOUCH CONTROL LAYER

(71) Applicant: SUPERC-TOUCH CORPORATION, New Taipei City (TW)

(72) Inventors: Hsiang-Yu LEE, New Taipei City (TW); Shang CHIN, New Taipei City (TW); Ping-Tsun LIN, New Taipei City (TW)

(21) Appl. No.: 18/731,475

(22) Filed: Jun. 3, 2024

(30) Foreign Application Priority Data
Jun. 5, 2023 (TW) 112120823

(51) Int. Cl. G02B 1/14; G06F 3/044

(52) U.S. Cl. CPC G02B 1/14; G06F 3/0443; G06F 2203/04102; G06F 2203/04111

(57) ABSTRACT

A protection film structure with bendable touch control layer includes a transparent substrate, at least one composite hardening layer and a touch-control layer. The transparent substrate includes a first face and a second face, where the first face is attached to or faces a display. The at least one composite hardening layer is arranged on the second face facing a user and each includes a first hardening layer and a second hardening layer. The first hardening layer is arranged at outer surface of the composite hardening layer. The touch-control layer is arranged between the first hardening layer and the second hardening layer and includes a plurality of electrode islands. The transparent substrate is a polymer substrate or a super-thin glass substrate with thickness not larger than 200 um.

### BACKGROUND

### Technical Field

The present invention relates to a protection film structure, especially to a protection film structure with bendable touch control layer.

### Description of Related Art

FIG. 1 shows a schematic diagram of a related art electronic product 100′ with a foldable display screen in folded status. The electronic product 100′ is, for example, a smartphone with a foldable display screen or an e-book apparatus with electronic paper. FIG. 2 shows a partial cross-sectional view of the electronic product 100′ with a foldable display screen. As shown in FIG. 2, the electronic product 100′ has, from top to bottom with reference to normal operation orientation, at least a protection layer 10′, a touch control layer 20′ and a flexible (or foldable) display screen 30′. This protection layer 10′ is required to have enough hardness to provide scratch resistance, and the transparency of the protection layer 10′ is preferably greater than 70%. As the material hardness or the thickness of the protection layer 10′ becomes larger, the more likely the protection layer 10′ has risk of breaking when the electronic product 100′ is bent or folded.

FIGS. 3A and 3B are schematic views for explaining the cracking problem of the protection layer 10′ when the electronic product 100′ is bent or folded. As shown in those figures, the protection layer 10′ in related art electronic product 100′ generally lacks of sufficient flexibility because the material hardness or the thickness of the protection layer 10′ should be larger enough to resist scratch. This causes the protection layer 10′ to break when the electronic product 100′ is bent or folded. Accordingly, the touch control layer 20′ below the protection layer 10′ may also have internal breakage. In a worse scenario, the display screen may also be damaged to cause degraded display of the electronic product 100′ or erroneous operation. On the contrary, the material hardness or the thickness of the protection layer 10′ for related art flexible (or foldable) display screen 30′ may be reduced to enhance the flexibility. However, the hardness will be insufficient to cause fragmentation and scratching problems when foreign objects contact with the protection layer 10′.

The object of the present invention is to solve the above problems. The present invention arranges a plurality of composite hardening layers on a foldable and flexible transparent substrate to provide a protection film structure that is resistant to bending, folding, and scratching. Besides, the present invention separates ITO (Indium tin oxide) layer into islands to provide bending ability to the ITO layer. Besides, the separated ITO islands are connected by metallic conductive wires with extensible and ductile property to form touch electrodes. Therefore, the problem of failing to bend in related art touch electrode can be solved.

### SUMMARY

The present invention is intended to overcome the drawbacks of related art. Accordingly, the present invention provides a protection film structure with bendable touch control layer, the protection film structure comprising:
a transparent substrate comprising a first face and a second face, wherein the first face is attached to or faces a display;
at least one composite hardening layer arranged on the second face facing a user and each of the at least one composite hardening layer comprising a first hardening layer and a second hardening layer; the first hardening layer being arranged at an outer surface of the composite hardening layer;
a touch control layer arranged between the first hardening layer and the second hardening layer and comprising a plurality of electrode islands;
wherein the transparent substrate is a polymer substrate (such as transparent PI or PET) or a super-thin glass substrate with thickness not larger than 200 um.

According to an embodiment of the present invention, an area of each of the electrode islands is not more than 5 square centimeters or an area of each of the electrode islands is not more than 1 square centimeter. A distance between at least 60% of adjacent electrode islands when viewed from the projection direction is not less than 3 μm.

According to an embodiment of the present invention, the protection film structure further includes a plurality of bridging conductors, the electrode islands corresponding to the touch electrode are electrically connected by the bridging conductor to form the touch electrode. Each of the bridging conductors is conductive strip composed of metal conductors with a wire diameter not more than 50 μm, or a metal connecting wire network composed of metal conductors with wire diameter not larger than 50 μm

### BRIEF DESCRIPTION OF THE DRAWINGS

FIG. 1 shows a schematic diagram of a related art electronic product with a foldable display screen in folded status.

FIG. 2 shows a partial cross-sectional view of the electronic product with a foldable display screen.

FIGS. 3A and 3B are schematic views for explaining the cracking problem of the protection layer when the electronic product is bent or folded.

FIG. 4A is a cross-sectional view of a composite hardening layer according to one embodiment of the present invention.

FIG. 4B is a cross-sectional view of a composite hardening layer according to an embodiment of the present invention.

FIG. 4C is a cross-sectional view of a composite hardening layer according to another embodiment of the present invention.

FIG. 4D is a cross-sectional view of the composite hardening layer according to another embodiment of the present invention.

FIG. 5A shows a cross-sectional view of a protection film structure with composite hardening layer according to an embodiment of the present invention.

FIG. 5B shows is a cross-sectional view of a protection film structure with composite hardening layer according to another embodiment of the present invention.

FIG. 5C shows a cross-sectional view of a protection film structure with composite hardening layer according to another embodiment of the present invention.

FIG. 5D shows a cross-sectional view of a protection film structure with composite hardening layer according to another embodiment of the present invention.

FIG. 5E shows is a cross-sectional view of a protection film structure with composite hardening layer according to another embodiment of the present invention.

FIG. 5F shows a cross-sectional view of a protection film structure with composite hardening layer according to another embodiment of the present invention.

FIG. 6 shows a cross-sectional view of a protection film structure with composite hardening layer according to another embodiment of the present invention.

FIG. 7A shows a cross-sectional view of the touch control layer according to the present invention.

FIG. 7B shows a cross-sectional view of the touch control layer according to the present invention.

FIG. 7C shows a cross-sectional view of the touch control layer according to another embodiment of the present invention.

FIG. 7D shows the top view of the touch control layer according to the present invention.

FIG. 7E is a partially enlarged view corresponding to dashed frame in FIG. 7D.

FIG. 8A shows the top view for the electrode islands according to an embodiment of the present invention.

FIG. 8B shows a sectional view along dashed line A in FIG. 8A.

FIG. 8C shows another sectional view along dashed line A in FIG. 8A.

FIG. 8D shows a sectional view along dashed line B in FIG. 8A.

FIG. 8E shows another sectional view along dashed line B in FIG. 8A.

FIG. 9A shows a top view of rugged surface on the substrate.

FIGS. 9B to 9D show sectional views of rugged surface on the substrate.

FIGS. 10A to 10C are sectional views for the protection film structure with composite hardening layer according to an embodiment of the present invention.

FIG. 10D is top view for the protection film structure with composite hardening layer according to an embodiment of the present invention.

FIGS. 11A to 11E are schematic view for showing manufacturing rugged face on the protection film structure of the present invention.

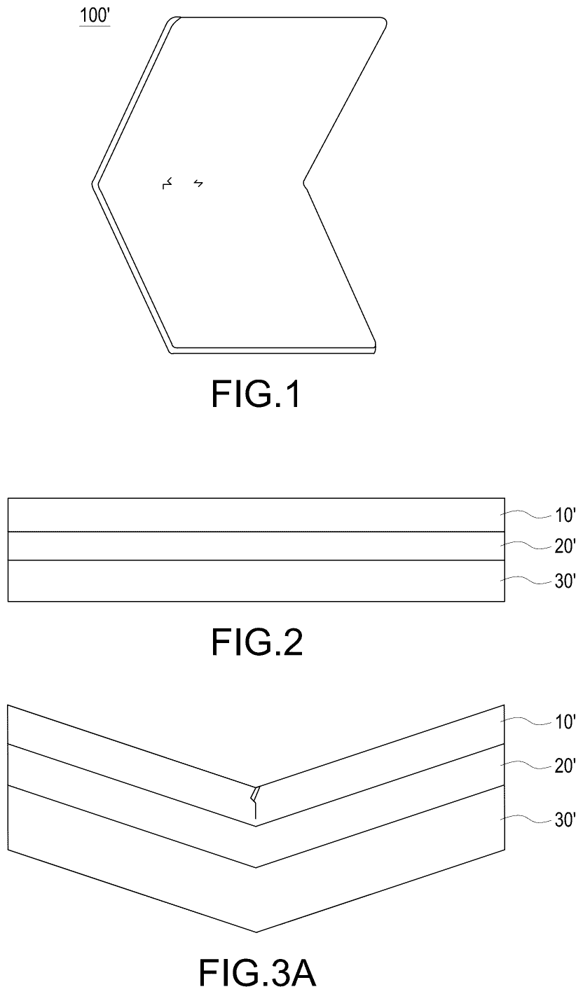

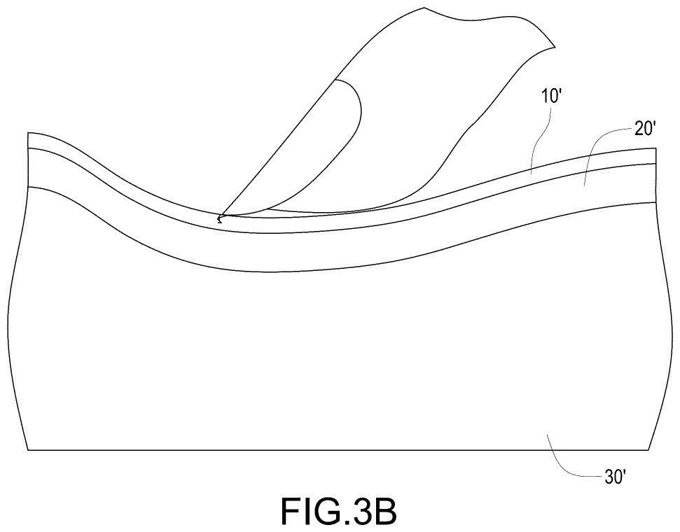

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present invention used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

The technical contents of the present invention will become apparent with the detailed description of embodiments and the accompanied drawings as follows. However, it shall be noted that the accompanied drawings are for illustrative purposes only such that they shall not be used to restrict the scope of the present invention.

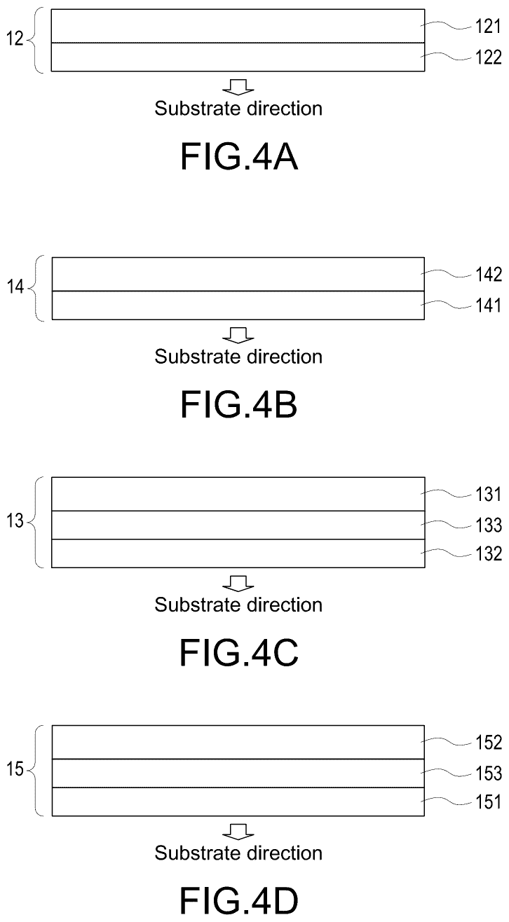

FIG. 4A is a cross-sectional view of a composite hardening layer according to one embodiment of the present invention. This composite hardening layer can be used in the protection film structure of the present invention and the detailed description will be given later. The composite hardening layer is, for example, a first composite hardening layer 12, and includes a first hardening layer 121 and a second hardening layer 122 from top to bottom. The above “from top to bottom” direction is referred to the normal orientation of the electronic product (such as a smart phone) with the composite hardening layer in usual operation. Namely, the user finger is on the top side, and the display screen of the smartphone is on the bottom side. However, the above definitions are only used to illustrate an exemplary direction of the technical features of the present invention, and are not intended to limit the scope of the present invention. FIG. 4B is a cross-sectional view of a composite hardening layer according to an embodiment of the present invention. This composite hardening layer can also be used in the protection film structure of the present invention and is, for example, a second composite hardening layer 14. The second composite hardening layer 14 includes a second hardening layer 142 and a first hardening layer 141 from top to bottom. In the embodiment shown in FIG. 4A and FIG. 4B, the first hardening layer 121 and 141 may be, for example, made of silicon nitride material (SiNx), and the hardness thereof is greater than 6H (namely, pencil hardness 6H). The second hardening layer 122, 142 may be, for example, a silicon oxide material (SiOx) with a hardness greater than 3H (namely, pencil hardness 3H) or an acrylic material with a hardness greater than 1H (namely, pencil hardness 1H). In addition, in the first composite hardening layer 12 shown in FIG. 4A, the hardness difference between the two adjacent hardening layers (namely, between the first hardening layer 121 and the second hardening layer 122) is preferably not less than the pencil hardness 3H; and the hardness of the first hardening layer 121 is greater than the hardness of the second hardening layer 122. In addition, in the second composite hardening layer 14 shown in FIG. 4B, the hardness difference between the two adjacent hardening layers (namely, between the first hardening layer 141 and the second hardening layer 142) is preferably not less than the pencil hardness 3H; and the hardness of the first hardening layer 141 is greater than the hardness of the second hardening layer 142.

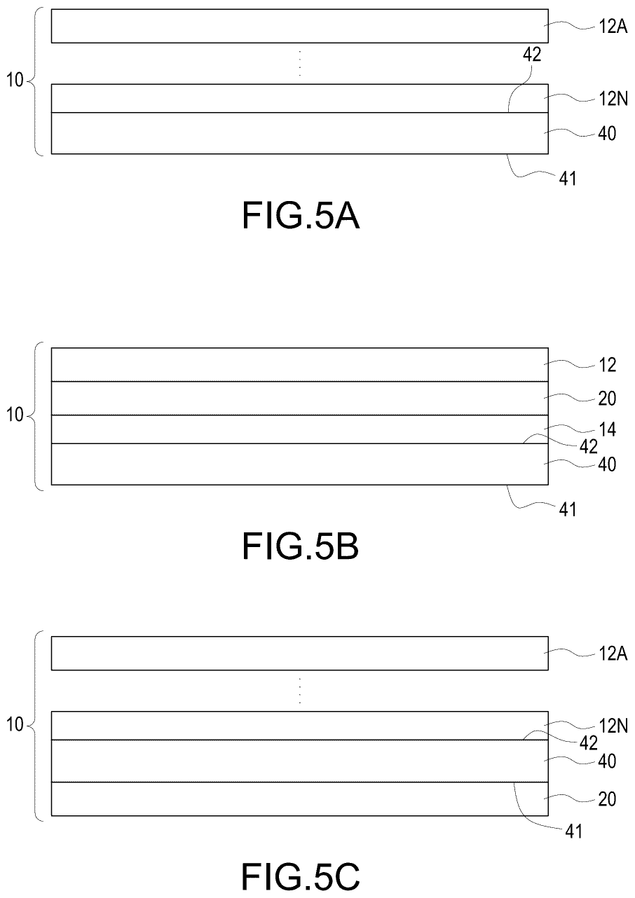

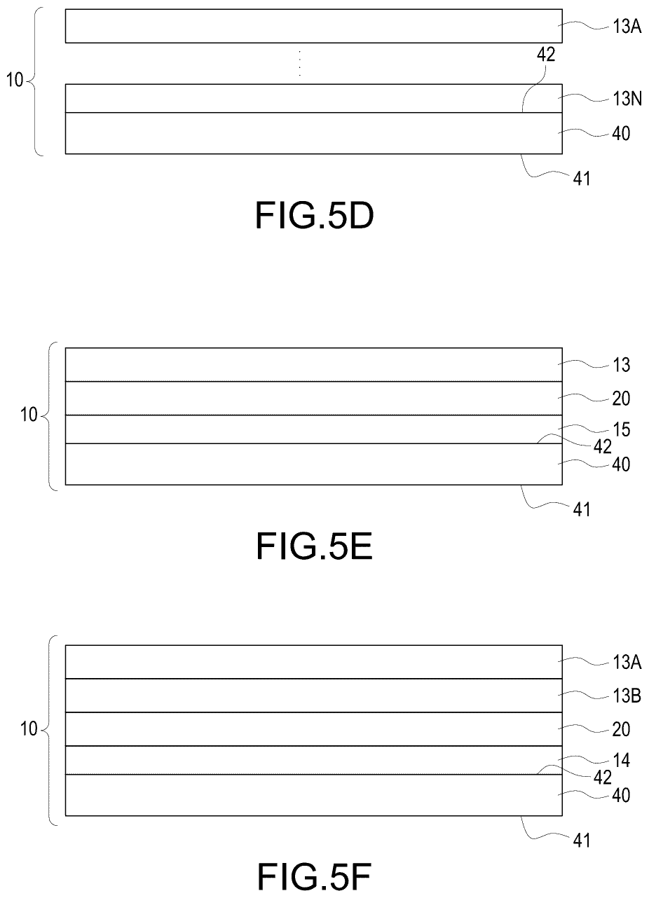

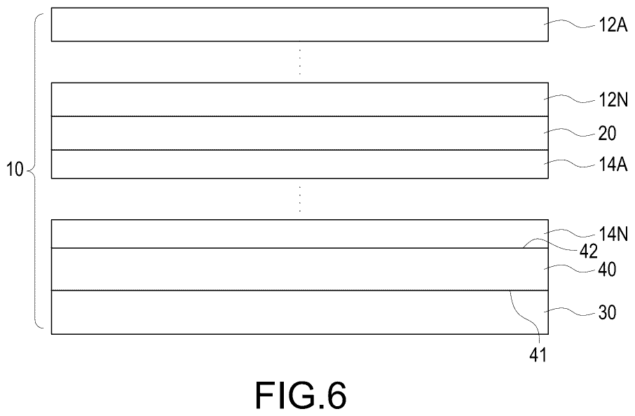

FIG. 4C is a cross-sectional view of a composite hardening layer according to another embodiment of the present invention. This composite hardening layer may also be used in the protection film structure of the present invention, and the detailed description will be given later. The composite hardening layer shown in FIG. 4C is, for example, a first composite hardening layer 13, and includes, from top to bottom, a first hardening layer 131, a third hardening layer 133 and a second hardening layer 132. FIG. 4D is a cross-sectional view of the composite hardening layer according to another embodiment of the present invention. The composite hardening layer shown in FIG. 4D is, for example, a second composite hardening layer 15, and includes, from top to bottom, a second hardening layer 152, a third hardening layer 153 and a first hardening layer 151. In the embodiment shown in FIG. 4C and FIG. 4D, the first hardening layers 131 and 151 may be, for example, made of silicon nitride material (SiNx), and the hardness thereof is greater than 6H (namely, pencil hardness 6H). Besides, the second hardening layers 132, 152 may be, for example, silicon oxide material (SiOx) and the hardness thereof are, for example, greater than 3H (namely, pencil hardness 3H). The third hardening layers 133 and 153 are, for example, made of acrylic material, and the hardness thereof is, for example, greater than 1H (that is, pencil hardness 1H). In addition, in the first composite hardening layer 13 shown in FIG. 4C, the material of the two adjacent hardening layers (namely, between the first hardening layer 131 and the third hardening layer 133, and between the third hardening layer 133 and the second hardening layers 132) is preferably not less than pencil hardness 3H. Besides, the hardness of the first hardening layer 131 is greater than the hardness of the second hardening layer 132. Furthermore, in the second composite hardening layer 15 shown in FIG. 4D, the material of the two adjacent hardening layers (that is, between the first hardening layer 151 and the third hardening layer 153, and between the third hardening layer 153 and the second hardening layers 152) is preferably not less than pencil hardness 3H. Besides, the hardness of the first hardening layer 151 is greater than the hardness of the second hardening layer 152. The composite hardening layer structure according to the present invention will be described in more detail in conjunction with the relevant figures. FIG. 5A shows a cross-sectional view of a protection film structure 10 with composite hardening layer according to an embodiment of the present invention. The protection film structure 10 of the present invention may, for example, include a plurality of first composite hardening layers 12 stacked to each other and a transparent substrate 40. Namely, as shown in FIG. 5A, the plurality of first composite hardening layers 12 includes, from top to bottom direction, the first composite hardening layer 12A . . . the first composite hardening layer 12N, where the transparent substrate 40 is arranged under the composite hardening layer 12N. The transparent substrate 40 includes a first face 41 and a second face 42, wherein the first face 41 is attached to or faces a protected device, such as a display screen (for example, the display screen may be the foldable display screen 30 in FIG. 6). As shown in FIG. 5A, at least one set of composite hardening layers (i.e., the first composite hardening layer 12A . . . the first composite hardening layer 12N) is disposed on the second face 42 of the transparent substrate facing the user (not shown). With reference also to FIG. 4A, each of the first composite hardening layers 12A . . . 12N includes at least two hardening layers of different materials, that is, the first hardening layer 121 and the second hardening layer 122, and the material hardness of the first hardening layer 121 is greater than the material hardness of the second hard layer 122. In the embodiment shown in FIG. 5A, the transparent substrate 40 can be a polymer material substrate, such as a transparent PI (polyimide) substrate or a PET (polyethylene terephthalate) substrate; or an ultra-thin glass substrate with a thickness not more than 200 μm (micrometer).

FIG. 5B shows is a cross-sectional view of a protection film structure 10 with composite hardening layer according to another embodiment of the present invention. The protection film structure 10 of the present invention may, for example, include a first composite hardening layer 12, a touch control layer 20, a second composite hardening layer 14 and a transparent substrate 40 from top to bottom. Similarly, the transparent substrate 40 includes a first surface 41 and a second surface 42, wherein the first surface 41 is attached to or faces a protected device, such as a display screen (for example, the foldable display screen 30 of FIG. 6). At least one set of composite hardening layer (namely, the first composite hardening layer 12 and the second composite hardening layer 14) is disposed on the second surface 42 of the transparent substrate 40, where the second surface 42 faces a user (not shown). Please also refer to FIG. 4A, the first composite hardening layer 12 includes at least two hardening layers (namely the first hardening layer 121 and the second hardening layer 122) made of different materials, and the material hardness of the first hardening layer 121 is greater than the material hardness of the second hardening layer 122. Furthermore, please also refer to FIG. 4B, the second composite hardening layer 14 includes at least two hardening layers (namely the first hardening layer 141 and the second hardening layer 142) made of different materials, and the material hardness of the first hardening layer 141 is greater than the material hardness of the second hardening layer 142. In the embodiment shown in FIG. 5B, the transparent substrate 40 can be a polymer material substrate (such as a transparent PI substrate or a PET substrate), or an ultra-thin glass substrate with a thickness not more than 200 μm.

FIG. 5C shows a cross-sectional view of a protection film structure 10 with composite hardening layer according to another embodiment of the present invention. The structure of this embodiment is similar to that in FIG. 5A. Namely, the first surface 41 of the transparent substrate 40 faces a protected device, such as a display screen (for example, the foldable display screen 30 of FIG. 6). At least one set of composite hardening layer (namely, the first composite hardening layer 12A . . . the first composite hardening layer 12N) is disposed on the second surface 42 of the transparent substrate 40, where the second surface 42 faces the user (not shown). The embodiment of FIG. 5C is different from the embodiment shown in FIG. 5A in that the embodiment shown in FIG. 5C further includes a touch control layer 20 disposed on the first surface 41 of the transparent substrate 40. Similarly, the transparent substrate 40 can be a polymer material substrate (such as a transparent PI substrate or a PET substrate), or an ultra-thin glass substrate with thickness not more than 200 μm.

FIG. 5D shows a cross-sectional view of a protection film structure 10 with composite hardening layer according to another embodiment of the present invention. The protection film structure 10 shown in FIG. 5D is similar to that shown in FIG. 5A, namely, the first face 41 of the transparent substrate 40 is attached to or faces a protected device, such as a display screen (for example, the display screen may be the foldable display screen 30 in FIG. 6). A plurality of composite hardening layers (namely, the first composite hardening layer 13A . . . the first composite hardening layer 13N) are arranged on the second face 42 of the transparent substrate facing the user (not shown). Please also refer to FIG. 4C, each of the first composite hardening layers 13A . . . 13N includes at least two hardening layers made of different materials, that is, the first hardening layer 131 and the second hardening layer 132 (where a third hardening layer 133 is sandwiched between the first hardening layer 131 and the second hardening layer 132). Besides, the material hardness of the first hardening layer 131 is greater than the material hardness of the second hardening layer 132. Similarly, in the embodiment shown in FIG. 5D, the transparent substrate 40 can be a polymer material substrate, such as a transparent PI (polyimide) substrate or a PET (polyethylene terephthalate) substrate; or an ultra-thin glass substrate with a thickness not more than 200 μm (micrometer).

FIG. 5E shows is a cross-sectional view of a protection film structure 10 with composite hardening layer according to another embodiment of the present invention. The embodiment shown in FIG. 5E is similar to that shown in FIG. 5B, namely, the protection film structure 10 shown in FIG. 5E also includes a first composite hardening layer 13, a touch control layer 20, a second composite hardening layer 15 and a transparent substrate 40 from top to bottom. Similarly, the transparent substrate 40 includes a first surface 41 and a second surface 42, wherein the first surface 41 is attached to or faces a protected device, such as a display screen (for example, the foldable display screen 30 of FIG. 6). At least one set of composite hardening layer (namely, the first composite hardening layer 13 and the second composite hardening layer 15) is disposed on the second surface 42 of the transparent substrate 40, where the second surface 42 faces a user (not shown). Please also refer to FIG. 4C, the first composite hardening layer 13 includes at least two hardening layers (namely the first hardening layer 131 and the second hardening layer 132) made of different materials. Besides, a third hardening layer 133 is sandwiched between the first hardening layer 131 and the second hardening layer 132. The material hardness of the first hardening layer 131 is greater than the material hardness of the second hardening layer 132. Furthermore, please also refer to FIG. 4D, the second composite hardening layer 15 includes at least two hardening layers (namely the first hardening layer 151 and the second hardening layer 152) made of different materials. Besides, a third hardening layer 153 is sandwiched between the first hardening layer 151 and the second hardening layer 152. The material hardness of the first hardening layer 151 is greater than the material hardness of the second hardening layer 152. In the embodiment shown in FIG. 5E, the transparent substrate 40 can be a polymer material substrate (such as a transparent PI substrate or a PET substrate), or an ultra-thin glass substrate with a thickness of not more than 200 μm.

FIG. 5F shows a cross-sectional view of a protection film structure 10 with composite hardening layer according to another embodiment of the present invention. The embodiment shown in FIG. 5F is similar to that shown in FIG. 5E. However, the embodiment shown in FIG. 5F has a plurality of first composite hardening layers 13 (such as first composite hardening layers 13A and 13B) arranged on the touch control layer 20. Besides, at least one second composite hardening layer 14 is arranged below the touch control layer 20. The structure of the first composite hardening layer 13 can be referred to the embodiment shown in FIG. 4C. Namely, the first composite hardening layer 13 is three-layered structure including, from top to bottom, a first hardening layer 131, a third hardening layer 133 and a second hardening layer 132. Besides, the material hardness of the first hardening layer 131 is greater than the material hardness of the second hardening layer 132. The structure of the second composite hardening layer 14 can be referred to the embodiment shown in FIG. 4B. Namely, the second composite hardening layer 14 includes, from top to down, a second hardening layer 142 and a first hardening layer 141. Besides, the material hardness of the first hardening layer 141 is greater than the material hardness of the second hardening layer 142. As can be seen from the embodiments in FIGS. 5E and 5F, the number of material layers in the composite hardening layer is not limited to two layers, and can be three layers as long as the material hardness of one hardening layer is greater than the material hardness of the other hardening layer.

FIG. 6 shows a cross-sectional view of a protection film structure 10 with composite hardening layer according to another embodiment of the present invention. The embodiment shown in FIG. 6 is similar to that shown in FIG. 5B. However, the protection film structure 10 shown in FIG. 6 includes a plurality of first composite hardening layers 12, namely the first composite hardening layer 12A . . . the first composite hardening layer 12N, atop the touch control layer 20. Besides, the protection film structure 10 shown in FIG. 6 further includes a plurality of second composite hardening layers 14, namely the second composite hardening layer 14A . . . the second composite hardening layer 14N, below the touch control layer 20. Besides, even not particularly depicted in FIG. 6, according to the present invention, the first composite hardening layers 12 atop the touch control layer 20 can be replaced by a plurality of first composite hardening layers 13, where each of the first composite hardening layers 13 has structure shown in FIG. 4C. Moreover, the second composite hardening layers 14 below the touch control layer 20 can be replaced by a plurality of second composite hardening layers 15, where each of the first composite hardening layers 15 has structure shown in FIG. 4D. In the embodiment shown in FIG. 6, a protected device, such as a foldable display screen 30, is arranged on the first face 41 of the transparent substrate 40.

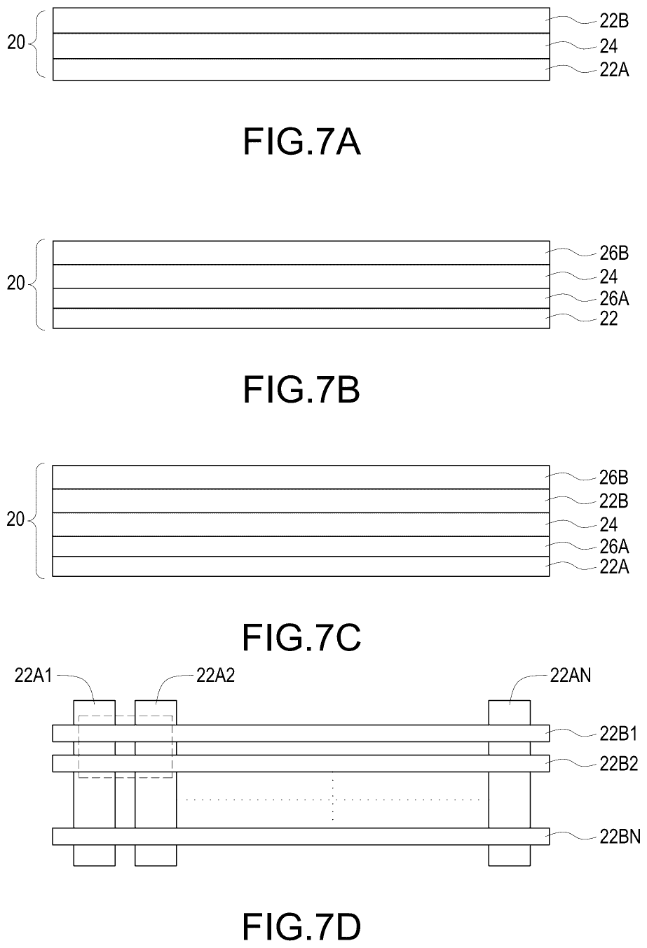

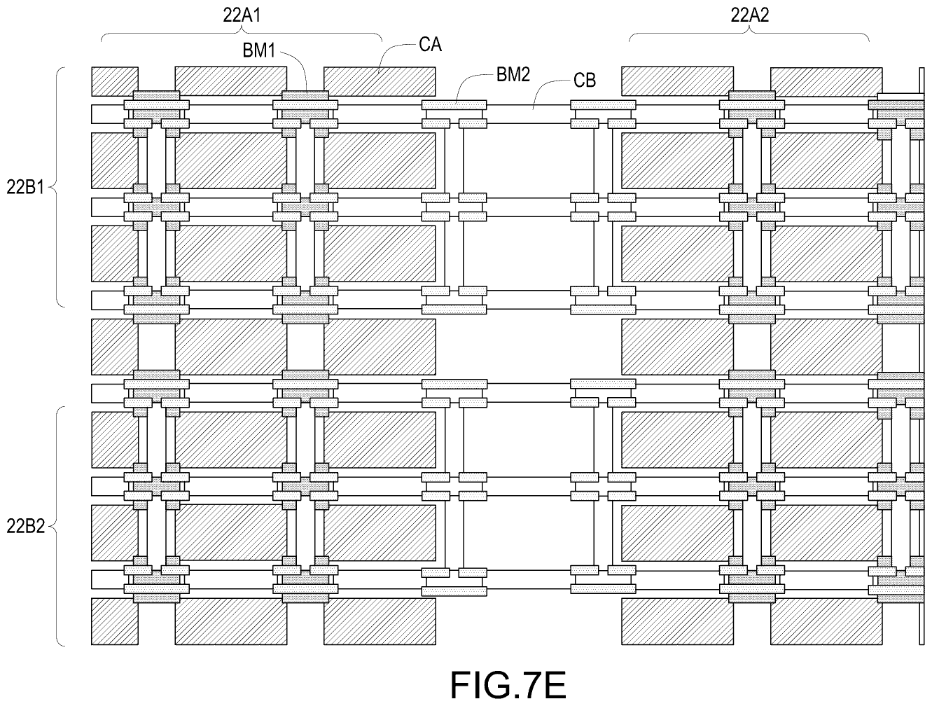

FIG. 7A shows a cross-sectional view of the touch control layer 20 according to the present invention. The prior art touch electrodes are made of transparent conductive material such as ITO.

The ITO material cannot be bent due to it is ceramic material and fragile. To overcome the drawbacks for prior art touch electrodes, which cannot be used in flexible display screen, the present invention separates touch electrodes made of ITO into ITO islands. Therefore, the thus-formed touch electrodes are bendable. Besides, the separated ITO islands are connected by ductile metal wires to form touch electrodes with functions similar to prior counterpart. More particularly, as shown in FIG. 7A, the touch control layer 20 is, for example, touch electrode layer for mutual-capacitance touch sensing and includes a first touch electrode layer 22A and a second touch electrode layer 22B separated by an insulating layer 24, where each of the touch electrode layers includes a plurality of touch electrodes. Please also refer to FIG. 7D, this figure shows the top view of the touch control layer 20 according to the present invention. The first touch electrode layer 22A may include strip-shaped electrodes (namely, the first touch electrodes 22A1, 22A2 . . . 22AN) arranged in columns. The second touch electrode layer 22B may include strip-shaped electrodes (namely, the second touch electrodes 22B1, 22B2 . . . 22BN) arranged in rows. Please both refer to FIGS. 7A and 7D, the touch electrodes of the first touch electrode layer 22A and the second touch electrode layer 22B are separated along a vertical direction (up and down direction) and the insulating layer 24 provides electric insulation between electrodes on different layers.

FIG. 7B shows a cross-sectional view of the touch control layer 20 according to the present invention. As shown in this figure, the touch control layer 20 is also touch electrode layer for mutual-capacitance touch sensing, while the transmitting electrodes and receiving electrodes are arranged on the same touch electrode layer 22. Besides, the touch electrodes (namely the first touch electrodes) used for transmitting signal are electrically connected through a first metal connection layer 26A, and the touch electrodes (namely the second touch electrodes) used for receiving signal are electrically connected through a second metal connection layer 26B. The first metal connection layer 26A and the second metal connection layer 26B are insulated with each other by the insulating layer 24.

FIG. 7C shows a cross-sectional view of the touch control layer 20 according to another embodiment of the present invention. The embodiment shown in FIG. 7C is similar to that in FIG. 7B, but the first touch electrode layer 22A and the second touch electrode layer 22B for realizing the mutual-capacitance touch sensing are arranged on different layers and separated by the insulating layer 24. Similar to the embodiment in FIG. 7B, the plurality of touch electrodes of the first touch electrode layer 22A are electrically connected through the first metal connection layer 26A, while the plurality of touch electrodes of the second touch electrode layer 22B are electrically connected through the second metal connection layer 26B. In above embodiments of FIGS. 7A to 7D, the touch electrodes are ITO electrodes.

FIG. 7E is a partially enlarged view corresponding to dashed frame in FIG. 7D. According to an embodiment of the present invention, each of the touch electrodes 22A1, 22A2 (or 22B1, 22B2) of the touch electrode layer includes a plurality of electrode islands CA (or CB). Besides, the plurality of electrode islands belonging to the same touch electrode are connected by a plurality of bridging conductor BM1 (or BM2) to form a corresponding touch electrode. As shown in FIG. 7E, a touch electrode of the first touch electrode layer 22A (for example, the first touch electrode 22A1 extending along the column direction) includes a plurality of electrode islands CA. The plurality of electrode islands CA belonging to the same touch electrode (such as the first touch electrode 22A1) are connected by a plurality of bridging conductor BM1 to form the corresponding first touch electrode 22A1. Similarly, a touch electrode of the second touch electrode layer 22B (for example, the second touch electrode 22B1 extending along the row direction) includes a plurality of electrode islands CB. The plurality of electrode islands CB belonging to the same touch electrode (such as the second touch electrode 22B1) are connected by a plurality of bridging conductor BM2 to form the corresponding second touch electrode 22B1.

Please refer to FIG. 7E again, each of the electrode islands CA (or CB) has area not more than 5 square centimeters. According to an embodiment of the present invention, the area of each electrode island is for example not more than 1 square centimeter. According to an embodiment of the present invention, the area of each electrode island is for example not less than 0.1 square centimeter. According to a preferred embodiment of the present invention, at least 60% of the electrode islands have area not larger than 5 square centimeters. Besides, for the electrode islands with area not larger than 5 square centimeters, the distance between at least 60% of adjacent electrode islands when viewed from the projection direction is not less than 3 μm. Besides, the bridging conductor can be, for example, made of aluminum, composite layer composed of molybdenum, aluminum, and molybdenum, or island-shaped transparent conductor. The bridging conductor can also be, for example, conductive strip composed of metal conductors with a wire diameter not more than 50 μm, or a metal connecting wire network composed of metal conductors with wire diameter not larger than 50 μm.

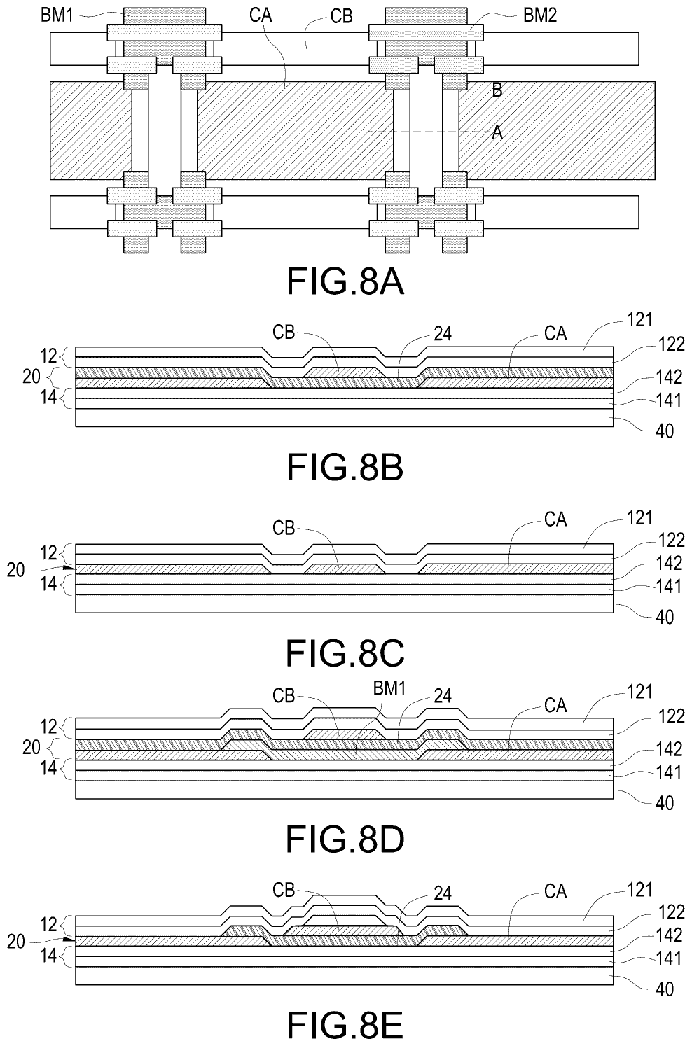

FIGS. 8A and 8B respectively show the top view for the electrode islands and sectional view along line A in FIG. 8A, which serve for further description of the present invention. FIG. 8B corresponds to the embodiment shown in FIG. 5B, namely, the embodiment shown in FIG. 8B also discloses a protection film structure 10 including a first composite hardening layer 12, a touch control layer 20, a second composite hardening layer 14 and a transparent substrate 40 from top to bottom. Please refer to FIG. 8B as well as FIG. 7A or 7C, the electrode islands CA corresponding to the touch electrode of the first touch electrode layer 22A and the electrode islands CB corresponding to the touch electrode of the second touch electrode layer 22B are separated by the insulating layer 24. Please refer to FIG. 8D, this figure shows the sectional view along line B in FIG. 8A and is corresponding to the structure shown in FIG. 8B. With reference also to FIG. 8B, the electrode islands CA corresponding to the first touch electrode of the first touch electrode layer 22A are electrically connected by the bridging conductor BM1 to form the first touch electrode. Besides, even though not clearly shown in FIG. 8D, the electrode islands CB corresponding to the second touch electrode of the second touch electrode layer 22B are electrically connected by the bridging conductor BM2 to form the second touch electrode.

FIGS. 8A and 8C respectively show the top view for the electrode islands and sectional view along dashed line A in FIG. 8A, which serve for further description of the present invention. FIG. 8C corresponds to the embodiment shown in FIG. 5B, namely, the embodiment shown in FIG. 8C also discloses a protection film structure 10 including a first composite hardening layer 12, a touch control layer 20, a second composite hardening layer 14 and a transparent substrate 40 from top to bottom. With reference to FIG. 8B and also to FIG. 7B, the electrode islands CA corresponding to the touch electrode of the first touch electrode layer 22A and the electrode islands CB corresponding to the touch electrode of the second touch electrode layer 22B are on the same plane. Please refer to FIG. 8E, this figure shows the sectional view along dashed line B in FIG. 8A and is corresponding to the structure shown in FIG. 8C. With reference also to FIG. 8C, the electrode islands CA corresponding to the first touch electrode of the first touch electrode layer 22A are electrically connected by the bridging conductor BM1 to form the first touch electrode. Besides, even though not clearly shown in FIG. 8E, the electrode islands CB corresponding to the second touch electrode of the second touch electrode layer 22B are electrically connected by the bridging conductor BM2 to form the second touch electrode.

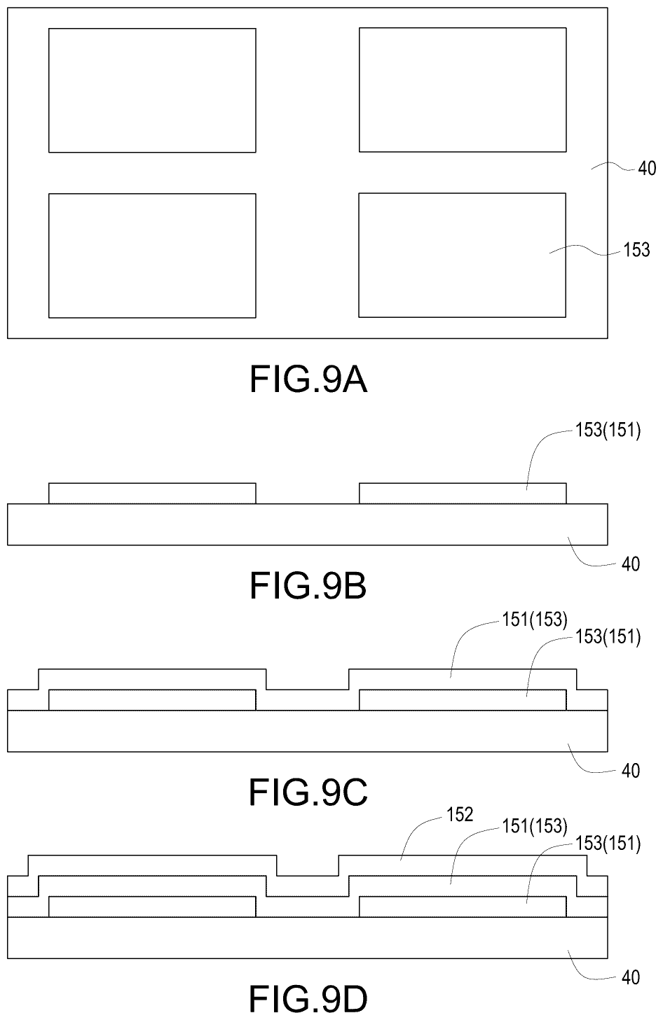

Please refer to FIGS. 9A to 9D, where FIG. 9A shows a top view of rugged surface on the substrate 40, and FIGS. 9B to 9D show sectional views of rugged surface on the substrate 40. The touch electrode in multiple electrode islands architecture help to reduce reflected light. Besides, electronic paper gradually becomes the mainstream of flexible displays, and electronic paper relies on light reflection from the electronic ink thereof to form images. This mechanism of electronic paper is different from LCD (with backlight) or from OLED (it produces images by emitting light from the screen thereof). Therefore, anti-reflective requirements on the surface of the protection film are higher and a larger reflection coefficient is disadvantageous for reading. The present invention intends to provide rugged face with different heights on the surface of the protection film to generate random reflections to reduce reflection coefficient. Besides, the rugged face on the surface of the protection film changes the hardening layer from two-dimensional structure to three-dimensional structure. If the hardening layer has local collapse due to the contact of foreign objects, the three-dimensional structure of the hardening layer is advantageous for the extension along transversal direction to prevent breaking of the hardening layer. Besides, when collapse happens, the height difference of the rugged face is reduced to increase the area of the hardening layer. Therefore, the hardening layer can withstand deeper collapse. The present invention can also form an island-shaped first hardening layer 151 or an island-shaped third hardening layer 153 on the substrate 40. As shown in FIG. 9A, the length of each island-shaped first hardening layer 151 or the length of each third hardening layer 153 are 5-1000 μm and the width thereof are also 5-1000 μm. As shown in FIG. 9C, the protection film structure of the present invention may include the third hardening layer 153 and the first hardening layer 151 from top to bottom; or the first hardening layer 151 and the third hardening layer 153 from top to bottom. As shown in FIG. 9D, the protection film structure may include a second hardening layer 152, a first hardening layer 151 and a third hardening layer 153 from top to bottom; or a second hardening layer 152, a third hardening layer 153 and a first hardening layer 151 from top to bottom. The specific structures of the first hardening layer 151, the second hardening layer 152 and the third hardening t layer 153 in FIGS. 9A to 9D can be referred to the embodiment of FIG. 4D. The first hardening layer 151 may be, for example, an inorganic material such as silicon nitride material (SiNx), and the hardness of the first hardening layer 151 may be greater than 6H (namely, pencil hardness 6H). The second hardening layer 152 may be, for example, an inorganic material such as a silicon oxide material (SiOx) and the hardness of the second hardening layer 152 is, for example, greater than 3H (namely, pencil hardness 3H). The third hardening layer 153 is, for example, an organic material (such as acrylic) or a transparent polymer material, and the hardness of the third hardening layer 153 is, for example, greater than 1H (namely, pencil hardness 1H). The structure in FIG. 9D can be used to replace the second composite hardening layers 14 and 15 in FIGS. 5B, 5E and 5F to provide anti-scratch and anti-cracking protection for the touch control layer 20 and the display screen.

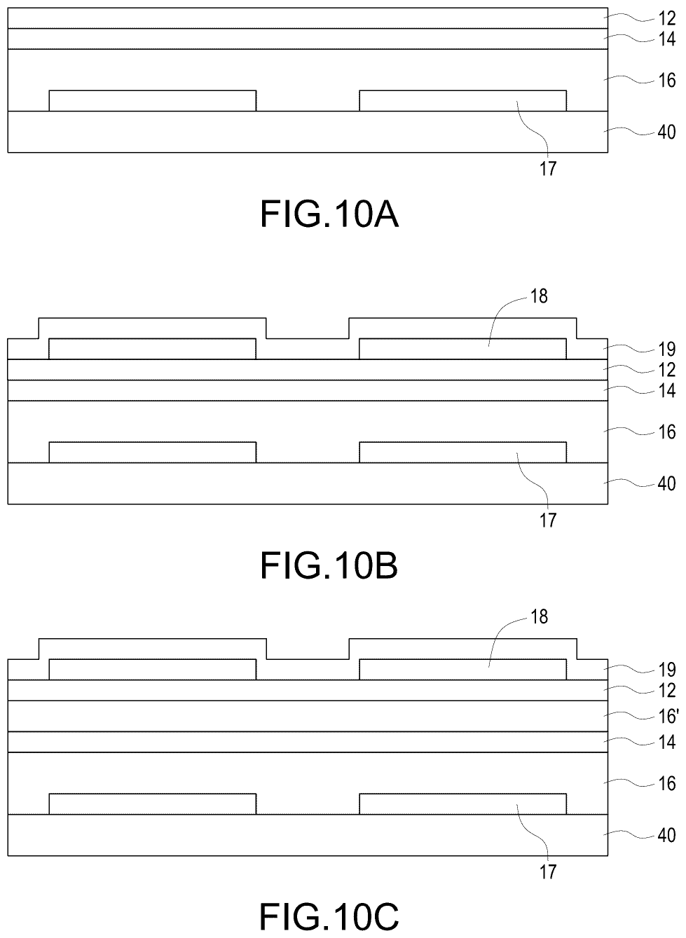

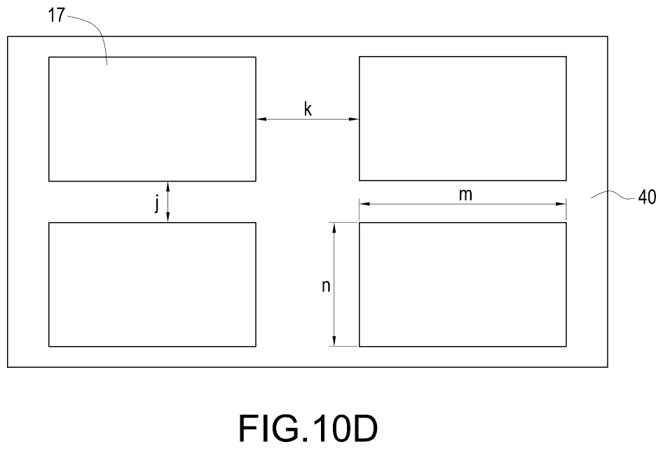

FIGS. 10A to 10C are sectional views and FIG. 10D is top view for the protection film structure with composite hardening layer according to an embodiment of the present invention. As shown in FIG. 10A, a plurality of island-shaped inorganic island blocks 17 (together forming the first island block layer) may be first formed on the transparent substrate 40. The material of the inorganic island blocks 17 may be, for example, silicon dioxide. Afterward, an organic tiling layer 16 is formed on the inorganic island block 17. The material of the organic tiling layer 16 may be, for example, acrylic, and the thickness thereof is not less than twice the thickness of the organic island block 17. Besides, a second composite hardening layer 14 and a first composite hardening layer 12 are respectively formed on the organic tiling layer 16. The material and structure of the first composite hardening layer 12 and the second composite hardening layer 14 can be referred to FIGS. 4A and 4B and related description. Besides, with reference to FIG. 10D, each of the island-shaped inorganic island blocks 17 is a polygon, such as a rectangle from top view. The length m of the rectangle is 5-1000 μm and the width n is also 5-1000 μm. In the shown embodiment, the shape of the island block is exemplarily to be rectangular. The shape of the island block in the present invention is not limited to this embodiment and can be triangle, circle, or various polygons.

In other embodiments of the present invention, the first island block layer may be made of organic material, such as acrylic material.

With reference to FIG. 10B, a plurality of organic island blocks 18 (together forming the second island block layer) can be formed on the structure obtained in FIG. 10A. The material of the organic island blocks 18 may be, for example, acrylic or photosensitive polyimide. Afterward, an inorganic hardening layer 19 is formed on the organic island blocks 18. The material of the inorganic hardening layer 19 is, for example, silicon nitride material (SiNx), and the thickness thereof is less than 2 μm. Besides, with reference to FIG. 10C, an intermediate organic tiling layer 16′ may also be formed between the first composite hardening layer 12 and the second composite hardening layer 14. The material of the intermediate organic tiling layer 16′ may be acrylic. Besides, the first composite hardening layer 12 and the second composite hardening layer 14 shown in FIGS. 10A to 10C can be multiple layer structure, or be replaced by the first composite hardening layer 13 and the second composite hardening layer 15 shown in FIGS. 4C and 4D.

According to other embodiments of the present invention, the second island block layer may be made of inorganic material, such as silicon dioxide or silicon nitride.

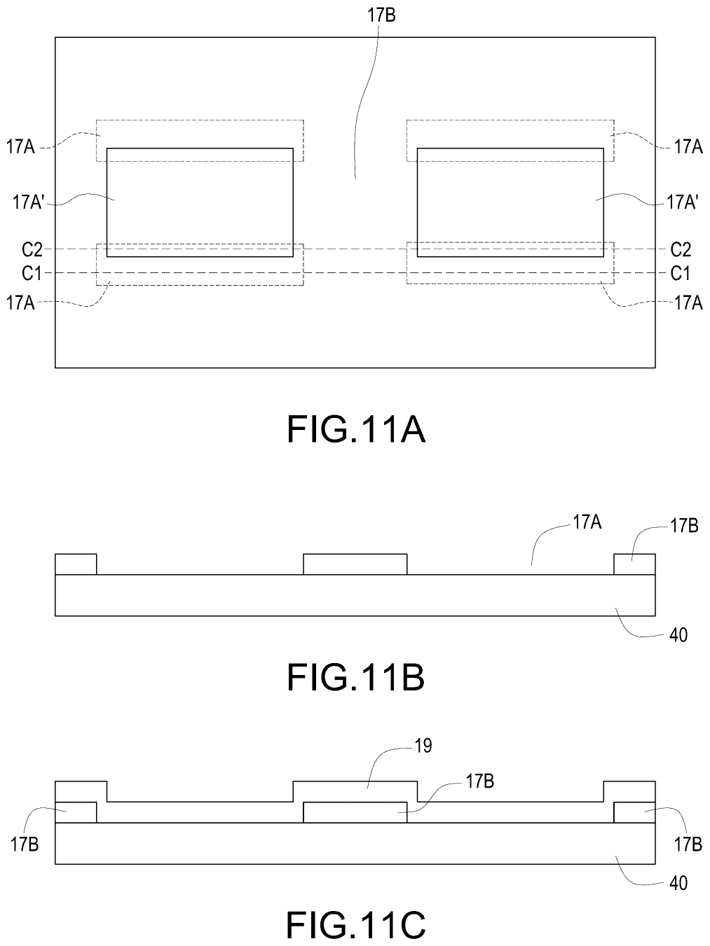

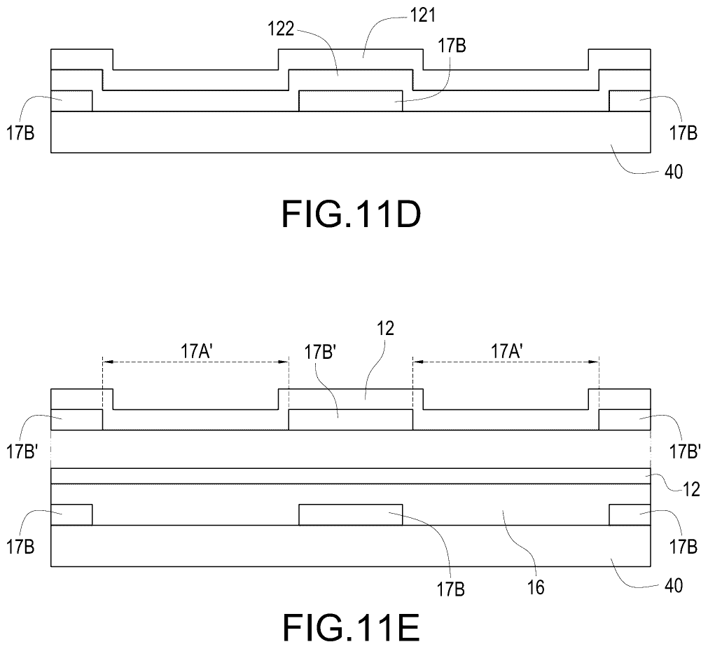

FIGS. 11A to 11E are schematic view for showing manufacturing rugged face on the protection film structure of the present invention. As shown in FIG. 11A, hollow island blocks 17A are first formed on the transparent substrate 40. Please further refer to FIG. 11B, which shows the sectional view along dashed line C1 in FIG. 11A. As shown in FIG. 11B, the hollow island blocks 17A are indent portion defined by the sidewall (grid structure) 17B. The indent portion of the hollow island blocks 17A may be a polygon (for example a rectangle), while the length of the rectangle is 5-1000 μm and the width is also 5-1000 μm. Besides, the material of the side wall (grid structure) 17B can be an inorganic material such as silicon dioxide, or an organic material such as an acrylic material. In the shown example, the hollow island blocks (first hollow island blocks) 17A are depicted as rectangular for the purpose of illustration. The shape of the hollow island blocks 17A in the present invention is not limited by this example, and can be triangular, circular, or various polygons. Please refer to FIGS. 11C, 11D and 11E, those figures are sectional view along dashed lines C1 and C2 in FIG. 11A. As shown in FIG. 11C, the sidewall (grid structure) 17B defining the hollow island blocks 17A are made of inorganic material (such as silicon dioxide). At least one inorganic hardening layer 19 is provided on the hollow island block layer. The inorganic hardening layer 19 is, for example, a silicon nitride hardening layer. As shown in FIG. 11D, the side walls (grid structure) 17B of the hollow island block 17A are made of organic material (such as acrylic material). At least one composite hardening layer is provided on the hollow island block layer. The composite hardening layer is, for example, the first hardening layer 121 made of silicon nitride stacked on the second hardening layer 122 made of silicon dioxide. FIG. 11E is sectional view along dashed line C2 in FIG. 11A. This embodiment includes two hollow island block layers. The first island block layer includes side wall (grid structure) 17B of inorganic material, which is disposed on the surface of the transparent substrate 40 to form a plurality of hollow island blocks 17A. A tiling layer (such as an organic tiling layer 16) and other corresponding structure is formed on the hollow island block 17A and the side wall (grid structure) 17B. The corresponding structure is, for example, the first composite hardening layer 12 and the second composite hardening layer 14 shown in FIGS. 10A to 10D. A second island block layer is provided on the top side of these composite hardening layers, and the second island block layer is, for example, a hollow island block (second hollow island block) 17A′ defined by a side wall grid structure 17B′ made of organic material (such as acrylic material). At least one composite hardening layer is arranged on the second hollow island block layer, and the composite hardening layer is, for example, a first hardening layer 121 made of silicon nitride stacked on a second hardening layer 122 made of silicon dioxide. In this embodiment, the hollow island blocks 17A and the auxiliary hollow island blocks 17A′ in different layers are preferably not completely overlapped in the projection direction.

The embodiments in FIGS. 11C, 11D and 11E employ the hollow island blocks 17A and/or the auxiliary hollow island blocks 17A′ to provide rugged face on the hardening layer to enhance the anti-bending and anti-scratch functions of the protection film structure. In above-mentioned embodiments, the protection film structure with composite hardening layer of the present invention includes at least two sets of composite hardening layers, such as the structures shown in FIGS. 5A to 5F, and FIG. 6. Besides, the protection film structure may include at least three sets of composite hardening layers, such as the structures shown in FIGS. 5F and 6. Each composite hardening layer includes at least two hardening layers of different materials, such as the two hardening layers shown in FIGS. 4A and 4B, or the three hardening layers shown in FIGS. 4C and 4D. Furthermore, the thickness of each first hardening layer in each of the above composite hardening layers is not greater than 2 μm, the sum of thickness of each first hardening layer of all composite hardening layers is not greater than 10 μm, and the thickness of each first hardening layer of all composite hardening layers is not less than 0.3 μm. Furthermore, the thickness of each second hardening layer in each of the above-mentioned composite hardening layers is not greater than 5 μm, the sum of thickness of each second hardening layer of all composite hardening layers is not greater than 15 μm, and the thickness of each second hardening layer of all composite hardening layers is not less than 0.5 μm. In above embodiments, the first hardening layer and the second hardening layer have such thickness configuration, and the material hardness of the first hardening layer is designed to be greater than the material hardness of the second hardening layer. Therefore, the composite hardening layer of the present invention is flexible, scratch-resistant and crack-resistant.

In the structures shown in FIGS. 8A to 8D, 9A to 9D, 10A to 10D, and 11A to 11D, by the provision of the electrode islands, island-shaped first hardening layer 151 or third hardening layer 153, inorganic island blocks 17, or hollow island block 17A, the surface of the hardening layer of the composite hardening layer is uneven with height difference not less than 0.1 μm, or the protection film structure facing the user having roughness (ruggedness) not less than 0.1 μm. The electronic products using this protection film structure has increased hydrophobicity and reduced reflection coefficient. In addition, the rugged surface also changes the hardening layer from a two-dimensional (planar) structure to a three-dimensional structure. If the hardening layer has local collapse due to the contact of foreign objects, the three-dimensional structure of the hardening layer is advantageous for the extension along transversal direction to prevent breaking of the hardening layer. Besides, when collapse happens, the height difference of the rugged face is reduced to increase the area of the hardening layer. Therefore, the hardening layer can withstand deeper collapse.

It shall be understood that the present invention may have other types of embodiments, and a person with ordinary skills in the art of the technical field of the present invention may make various changes and modifications corresponding to the present invention without deviating the principle and substance of the present invention; however, such corresponding changes and modification shall be within the claimed scope of the present invention.

What is claimed is:

1. A protection film structure with bendable touch control layer, the protection film structure comprising:
a transparent substrate comprising a first face and a second face, wherein the first face is attached to or faces a display;
at least one composite hardening layer arranged on the second face facing a user and each of the at least one composite hardening layer comprising a first hardening layer and a second hardening layer; the first hardening layer being arranged at an outer surface of the composite hardening layer;
a touch control layer arranged between the first hardening layer and the second hardening layer and comprising a plurality of touch electrodes, each of the touch electrodes comprising a plurality of electrode islands;
wherein the transparent substrate is a polymer substrate or a super-thin glass substrate with thickness not larger than 200 micrometers.

2. The protection film structure in claim 1, wherein an area of each of the electrode islands is not more than 5 square centimeters.

3. The protection film structure in claim 2, wherein an area of each of the electrode islands is not more than 1 square centimeter.

4. The protection film structure in claim 2, wherein an area of each of the electrode islands is not less than 0.1 square centimeter.

5. The protection film structure in claim 2, wherein a distance between at least 60% of adjacent electrode islands when viewed from a projection direction is not less than 3 micrometers.

6. The protection film structure in claim 1, further comprising a plurality of bridging conductors, wherein the electrode islands corresponding to one touch electrode are electrically connected by the bridging conductors to form the touch electrode.

7. The protection film structure in claim 6, wherein each of the bridging conductors is conductive strip composed of metal conductors with a wire diameter not more than 50 micrometers, or a metal connecting wire network composed of metal conductors with wire diameter not larger than 50 micrometers.

8. The protection film structure in claim 1, wherein the first hardening layer is made of silicon nitride (SiNx).
